(19) United States
(12) Patent Application Publication
(10) Pub. No.: US 2011/0035533 A1
(43) Pub. Date: Feb. 10, 2011

(54) SYSTEM AND METHOD FOR DATA-PROCESSING

(76) Inventors: In Hwan Doh, Seoul (KR); Sam Hyuk Noh, Seoul (KR)

Correspondence Address: HAYES SOLOWAY P.C., 3450 E. SUNRISE DRIVE, SUITE 140, TUCSON, AZ, 85718, US

(21) Appl. No.: 12/776,162

(22) Filed: May 7, 2010

(30) Foreign Application Priority Data
Aug. 5, 2009 (KR) 10-2009-0072065

(51) Int. Cl. G06F 12/00; G06F 1/24; G06F 15/16

(52) U.S. Cl. 711/102; 713/324; 709/223; 711/E12.001

(57) ABSTRACT

Disclosed is a data processing system and method. The data processing system may include a plurality of servers to process data, and a controller to shut off a power supplied to a server, among the plurality of servers, having data throughput less than a predetermined data throughput.

### CROSS-REFERENCE TO RELATED APPLICATION

This application claims the benefit of Korean Patent Application No. 10-2009-0072065, filed on Aug. 5, 2009, in the Korean Intellectual Property Office, the disclosure of which is incorporated herein by reference.

### BACKGROUND

1. Field

The present invention relates to a data processing system and method, and more particularly, to a system operating a plurality of data servers, namely, a data processing system and method that conserves energy in a data center effectively operating a server.

2. Description of the Related Art

A data center may operate a plurality of servers to process data. The data center may control a number of servers to be operated among the plurality of servers or may control a throughput processed in each server.

Accordingly, the throughput processed in each server of the data center may be different and there may exist a server that is not processing data among the servers in the data center. The data center continuously supplies energy even to an idle server that is not processing the data, thereby unnecessarily wasting the energy. Accordingly, although the data center uses a method of terminating the idle server to increase efficiency in utilizing energy, a large amount of time is expended for switching the terminated idle server into a state where data-processing is possible, and thus, the data center has a difficulty in smoothly processing the data.

Accordingly, there is a desire for a data processing system and method that may increase efficiency in utilizing energy while smoothly processing data.

### SUMMARY

An aspect of the present invention provides a system and method that improves energy efficiency in a data center that performs data processing using a plurality of servers.

Another aspect of the present invention provides a system and method that may appropriately control a number of servers that may be idle among a plurality of servers based on an amount of data and/or characteristic of the data, thereby increasing an energy efficiency and minimizing hardware usage of the server.

According to example embodiments, there may be provided a system of processing data, and the system may include a plurality of servers to process data, and a controller to shut off a power supplied to a server having data throughput less than a predetermined data throughput, among the plurality of servers.

Each of the plurality of servers may include a nonvolatile RAM as at least one portion of a main memory to maintain data being processed even when a power is shut off.

When the controller shuts off the power supplied to a predetermined server, the predetermined server may transmit the data being processed to a second server having data throughput greater than or equal to the predetermined data throughput.

According to example embodiments, there may be provided a system of processing data, and the system may include a plurality of servers to process data and a controller to determine, based on data information, whether each of the plurality of servers is operating, and to shut off a power supplied to an idle server that is not operating.

The idle server may include a nonvolatile RAM as at least one portion of a main memory to maintain data being processed even when a power is shut off.

The data information may include at least one of a total amount of data, data throughput of the plurality of servers, data process delaying time of the servers, data processing rate of the plurality of servers, operation time of the plurality of servers, a number of servers to be operated, and operation states of the plurality of servers.

The controller may determine, as the idle server, a server having data throughput less than a predetermined data throughput, a server having a data process delaying time less than a predetermined data process delaying time, a server having a data processing rate greater than or equal to a predetermined data processing rate, or a server having an operation time greater than or equal to a predetermined operation time to shut off the power supplied to the idle server.

When the controller shuts off the power supplied to the idle server, the idle server transmits the data being processed to an operational server that is operating.

According to example embodiments, there may be provided a method of processing data, and the method includes an operation of measuring an amount of data throughput processed in each of a plurality of servers, an operation of determining a server having data throughput less than a predetermined data throughput, from among the plurality of servers, and an operation of shutting off a power supplied to the server.

Additional aspects and/or advantages will be set forth in part in the description which follows and, in part, will be apparent from the description, or may be learned by practice of the embodiments.

### EFFECT

According to the present invention, energy efficiency is improved in a data center that performs data processing using a plurality of servers.

According to the present invention, a number of servers that may be idle among a plurality of servers is appropriately controlled based on an amount of data and/or characteristic of the data, thereby increasing an energy efficiency and minimizing a hardware usage of the server.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a configuration of a data processing system according to an exemplary embodiment of the present invention;

FIG. 2 is a diagram illustrating a configuration of a data processing system according to another exemplary embodiment of the present invention;

FIG. 3 is a flowchart illustrating a data processing method according to an exemplary embodiment of the present invention; and

FIG. 4 is a flowchart illustrating a data processing method according to another exemplary embodiment of the present invention.

### DETAILED DESCRIPTION

Reference will now be made in detail to example embodiments, examples of which are illustrated in the accompanying drawings, wherein like reference numerals refer to the like elements throughout.

Hereinafter, a data processing system and method according to an exemplary embodiment of the present invention will be described in detail.

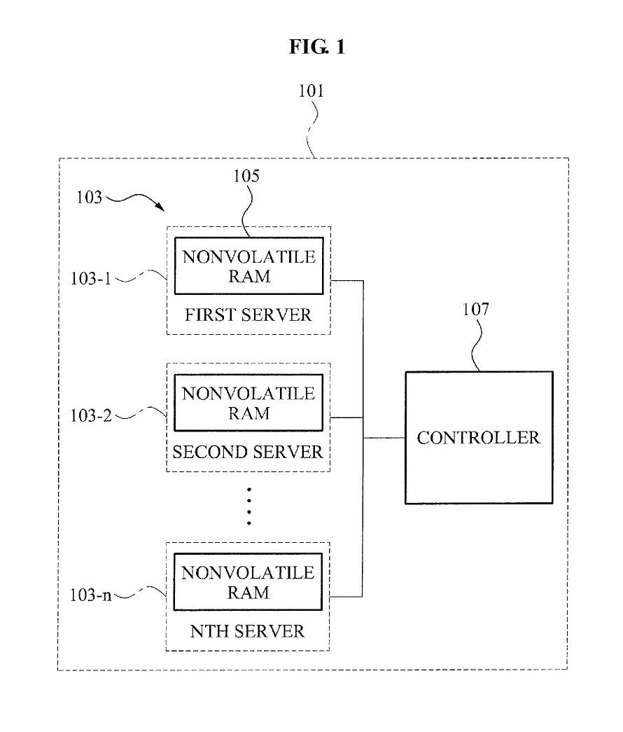

FIG. 1 illustrates a configuration of a data processing system 101 according to an exemplary embodiment of the present invention.

Referring to FIG. 1, the data processing system 101 may include a plurality of servers 103 and a controller 107. The plurality of servers 103 may include a first server 103-1 through an n^{th} server 103-n, and may process data. Here, n is a natural number. In this instance, each of the first server 103-1 through the n^{th} server 103-n may include a nonvolatile RAM 105 as at least one portion of a main memory to maintain data being processed even when a power is shut off.

The controller 107 may control a power supplied to a server based on data throughput of the server. Specifically, the controller 107 may shut off a power supplied to the first server 103-1 having data throughput less than a first predetermined data throughput among the plurality of servers 103. As an example, when data throughput of the first server 103-1 is 4 units, and data throughput of the second server 103-2 is 100 units, when the first predetermined data throughput that is a standard for determining power-shutoff is less than 5 units, the controller 107 may shut off the power supplied to the first server 103-1 because the data throughput of the first server 103-1 is less than the first predetermined data throughput, and the controller 107 may maintain a power supplied to the second server 103-2 since the data throughput of the second server 103-2 is greater than or equal to the first predetermined data throughput. Here, the first predetermined data throughput that is the standard for power-shutoff may be a numerical value or may be a range of values.

When the power supplied to the first server 103-1 is shut off, the first server 103-1 may transmit data being processed to the second server 103-2 having the data throughput greater than or equal to the first predetermined data throughput. In this instance, the second server 103-2 has the data throughput greater than or equal to the first predetermined data throughput, and thus, the power supplied to the second server 103-2 may be maintained. Also, when the power supplied to the first server 103-1 is shut off, the first server 103-1 may transmit the data being processed to a third server 103-3 having data throughput greater than or equal to the first predetermined data throughput and less than a second predetermined data throughput, thereby preventing data throughput from being concentrated into a single server. Here, the second predetermined data throughput is greater than the first predetermined data throughput.

The controller 107 may determine, based on data information, whether each of the plurality of servers 103 is operating, and may shut off a power supplied to an idle server that is not operating. Here, the data information may include at least one of a total amount of data on the plurality of servers 103, data throughput of the plurality of servers 103, data process delaying time of the servers, data processing rate of the plurality of servers 103, operation time of the plurality of servers 103, a number of plurality of servers 103 to be operated, and operation states of the plurality of servers 103.

As an example, the controller 107 may determine, as the idle server, a server having data throughput less than a predetermined data throughput, a server having a data process delaying time less than a predetermined data process delaying time, a server having a data process rate greater than a predetermined data process rate, or a server having an operation time greater than or equal to a predetermined operation time, and may shut off a power supplied to the idle server. In this instance, when a power is shut off, the idle server may transmit data being processed to an operational server that is operating.

The data processing system according to an exemplary embodiment of the present invention may not provide a power to all servers, and may selectively provide a power based on the data information, thereby improving an energy efficiency.

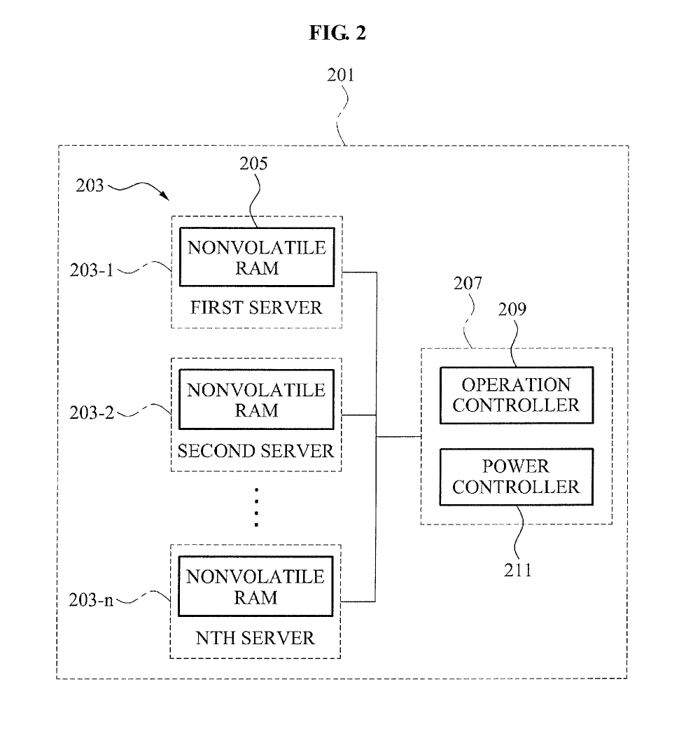

FIG. 2 illustrates a configuration of a data processing system 201 according to another exemplary embodiment of the present invention.

Referring to FIG. 2, the data processing system 201 according to another exemplary embodiment of the present invention may include a plurality of servers 203 and a controller 207.

The servers 203 may include a first server 203-1 through an n^{th} server 203-n, and may process data. Here, n is a natural number. In this instance, each of the first server 203-1 through the n^{th} server 203-n may include a nonvolatile RAM 205 as at least one of a main memory to maintain data being processed even when a power is shut off.

The controller 207 may include an operation controller 209 controlling an operation of a server, and a power controller 211 controlling a power of the server.

The operation controller 209 may determine a number of servers to be operated among the plurality of servers 203, and may operate servers corresponding to the number of the servers to be operated. Specifically, the operation controller 209 may determine the number of servers to be operated, based on at least one of a total amount of data to be processed by the plurality of servers 203, data throughput of the plurality of servers 203, data process delaying time of the servers, data processing rate of the plurality of servers 203, operation time of the plurality of servers 203, and operation states of the plurality of servers 203. Also, the operation controller 209 may calculate a minimum number of servers used for processing the total amount of the data of the plurality of servers 203, and may determine the minimum number of servers as the number of servers to be operated.

The power controller 211 may provide a power to an operational server that is operating, and may shut off a power supplied to an idle server that is not operating. The power controller 211 may refer to database (not illustrated) that stores power states of the plurality of servers 203, and may control a power of a corresponding server only when a power state of the corresponding server is changed. Specifically, when the operational server that has been operating is currently determined as an idle server that is not operating, a power state of the operational server is changed from a power supply state to a power shut-off state, and thus, the power controller 211 may control to shut off the power supplied to the corresponding server. When the idle server that has not been operating is determined as the operational server that is operating, a power state of the idle state is changed from the power shut-off state into the power supply state, and thus, the power controller 211 may control to supply a power to the corresponding server.

The data processing system may operate the same number of servers as the number of servers to be operated, and may shut off a power supplied to the idle server that is not operating, thereby improving an energy efficiency. In this instance, the data processing system may operate a minimum number of servers used for processing the data, and may shut off the power supplied to the idle server that is not operating, thereby maximizing the energy efficiency.

The data processing system may control the number of servers to be operated based on varying data information to effectively process the data, and may shut off a power supplied to the idle server whenever the number of the servers to be operated is changed, thereby increasing the energy efficiency.

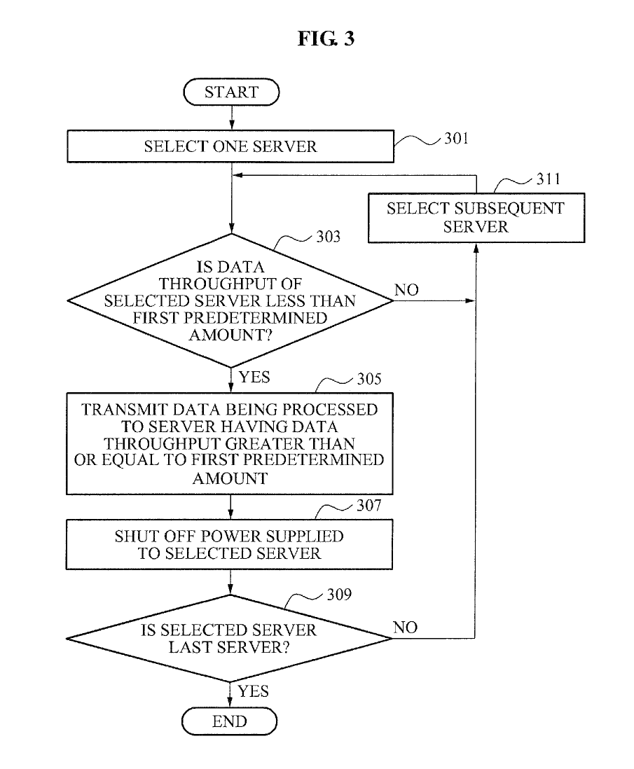

FIG. 3 illustrates a data processing method according to an exemplary embodiment of the present invention.

Referring to FIG. 3, the data processing system may select one of a plurality of servers and may measure data throughput processed in the selected server in operation 301.

The servers may include a first server through an n^{th} server, and may process data. Here, n is a natural number. In this instance, each of the first server through the n^{th} server may include a nonvolatile RAM that is capable of storing data being processed, as at least one portion of a main memory, even when a power is shut off.

The data processing system determines whether the data throughput of the selected server is less than a first predetermined data throughput in operation 303.

Specifically, when the data throughput of the selected server is less than the first predetermined data throughput, the data processing system transmits data being processed to a server having data throughput greater than or equal to the first predetermined data throughput in operation 305.

When the data throughput of the selected server is less than the first predetermined data throughput, the data processing system may transmit the data being processed in the selected server to a server having data throughput greater than or equal to the first predetermined data throughput and less than a second predetermined data throughput, thereby preventing data throughput from being concentrated into a single server.

Subsequently, the data processing system may shut off a power supplied to the selected server in operation 307.

In this instance, when the power supplied to the selected server is shut off; the selected server may store, in the nonvolatile RAM included as at least one of portion of the main memory, the data being processed, and when a power is supplied again, the selected server may restore data to its previous state based on the data stored in the nonvolatile RAM to maintain the data.

Subsequently, when the data throughput of the selected server is greater than the first predetermined data throughput or the selected server is not the n^{th} server in operation 309, the data processing system may repeatedly perform an operation 311 of selecting a subsequent server, an operation 303 of comparing data throughput, an operation 305 of transmitting data, and an operation 307 of controlling a power supply.

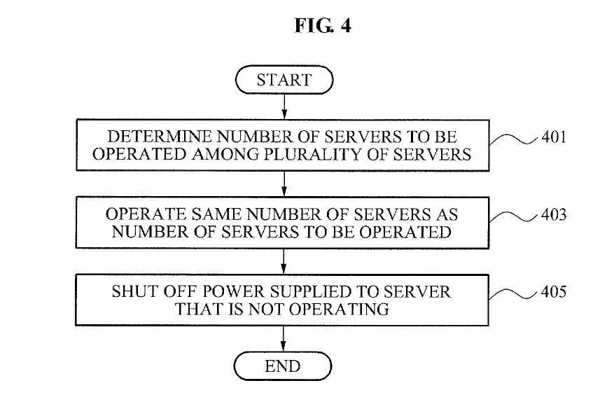

FIG. 4 illustrates a data processing method according to another exemplary embodiment of the present invention.

Referring to FIG. 4, a data processing system determines a number of servers to be operated among a plurality of servers in operation 401.

In this instance, the data processing system may determine the number of servers to be operated based on at least one of a total amount of data, data throughput of the plurality of servers, data process delaying time of the servers, data processing rate of the plurality of servers, operation time of the plurality of servers, and operation states of the plurality of servers. The data processing system may calculate a minimum number of servers used for processing the total amount of data of the servers, and may determine the minimum number of servers as the number of servers to be operated.

Subsequently, the data processing system may operate the same number of servers as the determined number of servers to be operated in operation 403.

The data processing system may process data using the operated servers among the plurality of servers.

Subsequently, the data processing system shuts off a power supplied a server that is not operating in operation 405.

The data processing system may supply a power to an operational server, and may shut off a power supplied to an idle server that is not operating. In this instance, since a power is shut off, the idle server may store data being processed in a nonvolatile RAM included as at least one portion of a main memory, and when a power is supplied again, the corresponding server may restore data to its previous state based on the data stored in the nonvolatile RAM to maintain the data.

Subsequently, the data processing system may control the number of servers to be operated based on varying data information. As an example, the data processing system may increase the number of servers to be operated when the amount of data increases, and may decrease the number of servers to be operated when the amount of data decreases. Accordingly, the data processing system may control the number of servers to be operated to effectively process the data, and may shut off a power supplied to the idle server when the number of servers to be operated is controlled, thereby increasing an energy efficiency.

Although a few example embodiments have been shown and described, it would be appreciated by those skilled in the art that changes may be made in these example embodiments without departing from the principles and spirit of the invention, the scope of which is defined in the claims and their equivalents.

What is claimed is:

1. A system of processing data, the system comprising:
a plurality of servers to process data; and
a controller to shut off a power supplied to a server having data throughput less than a predetermined data throughput, among the plurality of servers.

2. The system of claim 1, wherein each of the plurality of servers includes a nonvolatile RAM as at least one portion of a main memory to maintain data being processed even when a power is shut off.

3. The system of claim 2, wherein, when the controller shuts off the power supplied to a predetermined server, the predetermined server transmits the data being processed to a second server having data throughput greater than or equal to the predetermined data throughput.

4. A system of processing data, the system comprising:
a plurality of servers to process data; and
a controller to determine, based on data information, whether each of the plurality of servers is operating, and to shut off a power supplied to an idle server that is not operating.

5. The system of claim 4, wherein the idle server includes a nonvolatile RAM as at least one portion of a main memory to maintain data being processed while a power is shut off.

6. The system of claim 5, wherein data information includes at least one of a total amount of data, data throughput of the plurality of servers, data process delaying time of the servers, data processing rate of the plurality of servers, operation time of the plurality of servers, a number of servers to be operated, and operation states of the plurality of servers.

7. The system of claim 6, wherein the controller determines, as the idle server, a server having data throughput less than a predetermined data throughput, a server having a data process delaying time less than a predetermined data process delaying time, a server having a data processing rate greater than or equal to a predetermined data processing rate, or a server having an operation time greater than or equal to a predetermined operation time to shut off the power supplied to the idle server.

8. The system of claim 5, wherein, when the controller shuts off the power supplied to the idle server, the idle server transmits the data being processed to an operational server that is operating.

9. A system of processing data, the system comprising:
a plurality of servers to process data;
an operation controller to determine a number of servers to be operated among the plurality of servers, and to operate servers corresponding to the number of the servers to be operated; and
a power controller to supply a power to an operational server that is operating,
wherein each of the plurality of servers includes a non-volatile RAM as at least one portion of a main memory to maintain data being operated even when a power is shut off.

10. The system of claim 9, wherein the operation controller calculates a minimum number of servers used for processing a total amount of data, and determines the minimum number of servers as the number of servers to be operated.

11. The system of claim 9, wherein the operation controller determines the number of servers to be operated, based on at least one of a total amount of data, data throughput of the plurality of servers, data process delaying time of the servers, data processing rate of the plurality of servers, operation time of the plurality of servers, and operation states of the plurality of servers.

12. The system of claim 9, further comprising:
a database to store power states of the plurality of servers,
wherein, when a power state of a server is changed with reference to the database, the power controller controls a power of the server of which the power state is changed.

13. A method of processing data, the method comprising:
measuring an amount of data throughput processed in each of a plurality of servers;
determining a server having data throughput less than a predetermined data throughput, from among the plurality of servers; and
shutting off a power supplied to the server.

14. The method of claim 13, wherein the server further performs:
storing, in a nonvolatile RAM included as at least one portion of a main memory, data being processed, when the supplied power is shut off; and
restoring the data being processed into a previous state, based on data stored in the nonvolatile RAM, when the power is supplied again.

15. The method of claim 14, wherein the server further performs:
transmitting the data being processed to a second server having data throughput greater than or equal to the predetermined data throughput, when the supplied power is shut off.

16. A method of processing data, comprising:
determining a number of servers to be operated from among a plurality of servers processing data;
operating servers from among the plurality of servers, a number of the operating servers being the same as the determined number of servers; and
supplying a power to an operational server that is operating, and shutting off a power supplied to an idle server that is not operating,
wherein each of the plurality of servers includes a nonvolatile RAM as at least one portion of a main memory to maintain data being processed while a power is shut off.

17. The method of claim 16, wherein the determining comprises:
calculating a minimum number of servers used for processing a total amount of data; and
determining the minimum number of servers as the number of servers to be operated.
